(19) United States
(12) Patent Application Publication
(10) Pub. No.: US 2013/0282454 A1
(43) Pub. Date: Oct. 24, 2013

(54) Virtual Environment with Targeted Advertising and Rewards

(71) Applicant: LANDSLIDE IP GROUP, LLC, Cedarhurst, NY (US)

(72) Inventors: Michael Alpert, Cedarhurst, NY (US); Marcelo Ballona, Cedarhurst, NY (US)

(73) Assignee: Landslide IP Group, LLC, Cedarhurst, NY (US)

(21) Appl. No.: 13/866,787

(22) Filed: Apr. 19, 2013

Related U.S. Application Data
(60) Provisional application No. 61/635,531, filed on Apr. 19, 2012.

(51) Int. Cl. G06Q 30/02

(52) U.S. Cl. CPC G06Q 30/0209
USPC 705/14.12

(57) ABSTRACT

A computer system and computer-implemented method present a suite of challenging and entertaining mobile games, obstacles, or tasks (“challenges”) within a navigable virtual environment simulating a real world venue. Businesses may reach consumers in a targeted, non-invasive, and integrated way with promotions, coupons, merchandise, affinity points or other prizes presented within the virtual environment. Certain advertising and promotions may be sent to particular users based upon user preferences, past user activity, user location, and/or other factors. The rewards (such as points or prizes) offered may also be targeted and selected based upon user preferences, past user activity, user location, and/or other factors. The rewards may be redeemable and transferrable. The computer system may allow sponsors such as shopping mall owners and operators, retailers, non-profit organizations and other enterprises, or individuals, to customize their promotional offerings, advertising, and challenges based in part upon real time data about user behavior and preferences.

### CROSS-REFERENCE TO RELATED APPLICATIONS

This patent application claims the benefit of U.S. Provisional Patent Application No. 61/635,531, filed Apr. 19, 2012, which is incorporated by reference in its entirety.

### BACKGROUND OF INVENTION

1. Field of the Invention

The present invention relates to virtual environments, including those presented on mobile computing devices, smartphones, desktops, laptops, notebook, kiosks, etc., and offering targeted or other advertising and/or rewards.

2. Description of the Related Art

Conventional gaming and/or advertising systems are disclosed by U.S. Pub. Nos. 2010/0137053 (entitled “Mobile Scratch Off Advertising System”); 2012/0047017 (entitled “In-game Advertising”); 2009/0198580 (entitled “Distribution and Targeting of Advertising for Mobile Devices”); 2010/0211431 (entitled “Method and Apparatus for Advertising on a Mobile Gaming Device”); 2011/0258049 (entitled “Integrated Advertising System”); 2012/0040763 (entitled “Game-based Incentives for Location-based Actions”); 2011/0319148 (entitled “Virtual and Location-based Multiplayer Gaming”); 2008/0102947 (entitled “Delivery of Advertising into Multiple Video Games”); 2008/0096650 (entitled “Gaming System and Method Having Promotions Based on Player Selected Gaming Environment Preferences”); 2010/0113160 (entitled “Massively Multiplayer Online Gaming Through a Mobile Device”); and 2009/0017913 (entitled “Location-based Multiplayer Gaming Platform”), which are all incorporated herein by reference in their entireties.

Conventional reward programs also exist, such as the reward program that is disclosed by U.S. Pub. No. 2010/0257040 (entitled “Multi-Merchant Reward Points Payment System”), which is incorporated herein by reference in its entirety. However, conventional reward programs may lack mobility and customer interactivity, suffer from low customer loyalty or retention, place restrictions on the use of the rewards, and/or have limited types of rewards available to customers or other drawbacks.

### SUMMARY OF THE INVENTION

The present embodiments are directed toward a computer system and method that provide a platform for delivering to users and/or consumers a suite of challenging and entertaining mobile games, obstacles, or tasks (“challenges”) while, at the same time, allowing businesses or other groups (including governments, charities, organizations, affinity groups, and even individuals, such as a celebrity that wants to reach his/her fans) to reach consumers in a targeted, non-invasive, and integrated way with promotions, coupons, merchandise, affinity points or other prizes, offering benefits, advertising and/or other brand messaging (collectively referred to “rewards” herein) that may be locally or broadly customized, locally or broadly relevant, and/or locally or position-based. Moreover, the computer system and method may allow sponsors such as shopping mall owners and operators; retailers (including national chains, franchises and local independent operators); non-profit organizations and other enterprises, or individuals, to customize their promotional offerings and advertising based in part upon real time data about user behavior and preferences.

In one aspect, a computer system may be provided. The computer system may be configured to present targeted advertising information to a user within a gaming or virtual environment. The computer system may include a memory unit for storing instructions or code related to presenting a virtual environment representing or graphically depicting a real world environment/location on a display screen and allowing user navigation through or within the virtual environment. The real world environment being simulated by the computer system may be a shopping mall or other venue, and the virtual environment may include one or more virtual stores representing real world or actual stores. The computer system may include a processor configured to retrieve advertising information associated with the virtual or actual stores and user profile information stored in the memory unit (which may be used by the computer system when a user is online or offline, and the computer system may re-synch with the user once user goes back online). The user profile information may detail product, service, brand, retailer, location, chain, shopping, consumption, and/or other preferences of a particular user (including general or specific reward preferences). The processor may be further configured to retrieve the instructions from the memory unit and present the virtual environment representing a real world environment on the display screen and accept user input directing virtual navigation through the virtual environment, and present targeted advertising or other offerings based upon the user profile information and virtual or gaming challenges to the user within or superimposed upon the virtual environment. There are many ways that a user may collect value or rewards during a challenge, and most or all of the value or rewards may be controlled by either a retailer, venue, advertiser, sponsor, retailer, etc., or a combination thereof. While a challenge progresses and/or upon successful completion of the challenge, the processor may award value or rewards to a virtual banking account of the user that the user may subsequently electronically or physically redeem and/or transfer, such as remotely over a communications network. In another aspect, a computer system may be provided. The computer system may be configured to present targeted advertising information on a display screen. The computer system may include a memory unit for storing instructions or code related to presenting a gaming or virtual environment that includes a virtual representation or computer simulation of a real world environment/location and allowing user navigation through or within the virtual environment. The memory unit may store user profile information detailing preferences of a particular user, such as product, service, retailer, brand, location, and/or other shopping or consumer preferences. The computer system may include a processor configured to retrieve the instructions from the memory unit and present the virtual environment representing the real world environment on the display screen and accept user input directing virtual navigation through the virtual environment. The computer system may also present targeted advertising information based upon the user profile information, and a virtual or gaming challenge within or superimposed upon the virtual environment, on the display screen. When the user successfully completes the challenge within the virtual environment, or even as the challenge progresses, the processor may award value or rewards to a virtual bank account of the user. After which, the value or rewards may be electronically or physically redeemable by the user when making a purchase or be electronically transferable by the user to another person or an organization over a communications network.

In another aspect, a computer-implemented method associated with presenting targeted advertising within a virtual environment and/or awarding value during, or upon successful completion of, virtual challenges presented on a display screen may be provided. The computer-implemented method may include displaying a gaming or virtual environment on the display screen. The virtual environment may include a virtual representation or computer simulation of a real world location, such as a shopping mall or other venue or area with numerous merchants. The computer-implemented method may include accepting user instructions directing navigation or movement (such as first or third person movement or icon movement or avatars, although not necessarily under user control) through the virtual environment; and retrieving advertising information associated with an actual store located within the real world location and user profile information detailing user preferences of a particular user from a memory via a processor. The computer-implemented method may include creating targeted advertising information, such as by filtering the advertising information using the user profile information to identify targeted advertising information pertinent to the particular user via the processor; presenting the targeted advertising information within or superimposed upon the virtual environment on the display screen; and presenting a virtual or gaming challenge to the user within or superimposed upon the virtual environment. During the challenge and/or upon successful completion of the challenge by the user, the computer-implemented method may include awarding value or rewards to a virtual bank account of the user via the processor; and accept user instructions via a communications network to subsequently electronically redeem or transfer the value or rewards accumulated in the virtual bank account.

The present invention is defined by the following claims. Nothing in this section should be taken as a limitation on those claims. Further aspects and advantages of the invention are discussed below in conjunction with the preferred embodiments and may be later claimed independently or in combination.

### DESCRIPTION OF THE DRAWINGS

The present embodiments will become more fully understood from the detailed description given herein below and the accompanying drawings which are given by way of illustration only, and are not limitative of the present invention, and wherein:

FIG. 1 illustrates an exemplary computer system configured to present targeted advertising, value, and/or challenges to a particular user within a virtual environment displayed on a display screen based at least in part upon user profile information; and

FIG. 2 illustrates an exemplary computer-implemented method of presenting targeting advertising, value, and/or challenges to a particular user within a virtual environment displayed on a display screen based at least in part upon user profile information.

### DETAILED DESCRIPTION

The embodiments described herein include a computer system and method that provide a platform for delivering to consumers a suite of challenging and entertaining mobile “challenges” (such as computer-based or virtual tasks, obstacles, games, or actions) while, at the same time, allowing businesses, organizations, groups, individuals, or the like to reach consumers in a targeted, non-invasive, and integrated way with promotions, coupons, advertising, consideration, and other brand messaging that may be locally customized and/or broadly relevant. Moreover, the platform may allow sponsors such as shopping mall owners and operators; retailers (including national chains, franchises and local independent operators); non-profit organizations and other enterprises to customize their promotional offerings and advertising based upon user preferences, user location, and/or real time data about user behavior and preferences.

In general, the present embodiments may include a computer system and method that provides a virtual environment and in-game navigation about the virtual environment. The virtual environment and in-game navigation may be provided by instructions and computer code stored in a memory unit. The virtual environment and in-game navigation may be configured to run on hand-held computing devices, such as smart phones, tablets, etc. The virtual environment may be a computer simulation and/or include a virtual mimic of a real world or actual venue, such as a store, shopping mall, shopping area or place, downtown area, venue with a number of merchants, or other real world location. The virtual environment may include virtual cities, areas, venues, stores, obstacles, advertising, and/or people. The user may navigate within the virtual environment by touch screen, key board, joystick, or other means.

The virtual “challenges” may be entertaining and fun to use and, at the same time, may offer users relevant and valuable rewards, such as coupons, merchandise, affinity points, and/or other prizes. An exemplary challenge may take place within a virtual likeness of Washington D.C.'s iconic Union Station. As such, the target audience may potentially include D.C. commuters, tourists and/or locals.

As an example, data may reveal that 40 million people pass through Union Station annually, approximately 25 million of whom pass through regularly; and the average shopper in the mall may be 37 years old with an annual household income of $64,000. Such demographic information may be used to present general targeted advertising and rewards to users. Alternatively or additionally, such demographic information may be combined with user profile information detailing user preferences to present specific targeted advertising, rewards, and/or challenges to users.

In addition to enjoying playing the challenges for their entertainment value, users may accumulate rewards as previously defined, such as points, prizes, coupons, and rebates (collectively referred to as “value” herein) that may be relevant, or of likely interest, to each user based upon preferences and tastes that he or she specifies in their user profile. The user preferences may include product, service, store, chain, retailer, sponsor, brand, product type, service type, location, day or week, shopping, consumer, consumer habit, and/or other preferences associated with a particular user. Value may be sponsored by many of the more than 100 premiere restaurants and retailers located within Union Station or another mall, venue, or location.

With the Union Station exemplary challenge, users may be able to simulate walking through a virtual replica of the landmark mall and encounter in virtual space what they might encounter in the real Union Station, including the same restaurants, stores and kiosks; crowds of people; billboards and other advertising and more. There may be virtual obstacles for the user to overcome, and challenging games to play. The first challenge may accommodate one user or player at a time. Other challenges may allow for a multiuser or multiplayer experience.

While going through the virtual Union Station, players may encounter such things as in-game advertising (e.g., banner, pop-up, and/or interactive advertising), coupons and other promotional offers, and coins or points to accumulate. Along the way, users may be able to virtually “grab” rewards and value, such as coupons, discounts, and/or other promotions, and store the rewards and value in a virtual bank associated with the user. Players may win points (depicted as coins or other icons) by overcoming obstacles, or after spending a certain amount of time, or traveling so far, within the challenge or virtual environment. Users may be able to specify preferences before starting or even within challenges so that advertising, rewards, value and/or prizes presented will or will likely appeal to them.

Users may also encounter within their challenges sponsored “hot spots,” or areas within the virtual environment or a challenge that may be dedicated to a particular sponsor or promotional partner. If users choose to “enter” a hot spot, they may win a prize, coupon, or other reward or value, or they may encounter a game or dedicated challenge to play to win rewards or value, such as rewards or value being offered by the sponsor or promotional partner, or rewards or value being targeted to the user based upon user preferences. Challenges may offer access to hot spots based upon sponsor-related criteria (e.g., if a retailer wants to promote heavily on a particular day, they may sponsor a hot spot that will be offered to users with a frequency based upon pricing or other considerations) and/or user activity (e.g., minutes spent playing or playing a challenge for a certain amount of time may trigger access to a hot spot). Sponsor-related criteria may be based upon demographic information, user preferences (such as those discussed elsewhere herein), age, wealth, product, service, pricing, timing, and/or other criteria, including those discussed elsewhere herein. Additionally or alternatively, hot spots may come and go within a challenge and change at various time periods (such as randomly, weekly, daily, hourly, or less or more frequently). The timing and access to hot spots may be determined by the challenge sponsors' and/or promotional partners' criteria or preferences.

In one embodiment, mobile software applications, commonly referred to as “Apps,” may be used by and integrated with the computer system. An App may be a software application designed to run on smartphones, tablets, and other computers. Apps may be available through application distribution platforms, including websites. Some Apps are free, and others have a price. Usually Apps may be downloaded over the internet from the platform to a hand-held device, but they may also be downloaded to laptops and desktop computers.

When a user first downloads an App or other code using the computer system of the present embodiments, the user may be prompted to create a profile. Alternatively, the computer system may grant the user some free or demo play for a certain period of time before requiring the user to register. Registration may require certain mandatory information, and other information may be optional. The information in the user profile may facilitate the user being offered or receiving challenges offering prizes and rewards that are more attractive to that user. User profile information may also enable sponsors to target their advertising and rewards more effectively.

Users may specify certain general preferences (General Reward Preferences) relevant across all challenges. Within specific challenges, users may be able to specify more narrow preferences (Challenge Specific Preferences). Challenge Specific Preferences, for instance, may specify that offers from certain stores or restaurants are particularly relevant and appealing to the user. In the course of playing a challenge, users may be offered value which may be stored in a virtual bank and later redeemed at another, more convenient time.

The challenges may be developed in such a way so as to offer targeted or specific value to users that may be relevant and appealing to them based upon their user profiles and past behavior (e.g., based upon what coupons or offers a user has taken up in the past). Challenges may offer certain coupons and rewards directly in-game. Rewards may also be available by redeeming coins or points accumulated during game play.

The computer system may also make available to users the option of “donating” points or rewards, or income generated off of the user, i.e., revenues generated from multiple revenue streams. Users may donate rewards to qualified charitable organizations or family and/or friends. For instance, a family or a number of friends may pool their rewards to purchase a product, service, and/or other prize.

In one embodiment, the computer system may present a platform that provides a virtual gaming environment in which one or more virtual challenges are presented to the user. The challenges may be directed toward to a targeted audience and/or sent to specific users based upon user profile or preference information, past user activity, user location (such as GPS location), and/or other criteria. During the challenges, the user may be presented with and collect targeted “value,” such as coupons, rebates, points, prizes, and other rewards, and the value may be targeted to the user based upon user profile information, past user activity, user location, and/or other criteria.

Additionally, during the challenges, the virtual environment may present targeted advertising to the user, such as advertising or promotions based upon user profile information, past user activity, location, and/or other criteria. During the challenges, targeted advertising, targeted rewards/value, and/or targeted challenges may be dynamically generated, presented, and/or altered in real time (or preprogramed or based upon criteria from advertisers, ad agencies, sponsors, retailers, venues, a company or platform provider, etc, and may be based on many players or one player in the chain) based upon sponsor criteria, user activity, user preferences, and/or other factors to create a “hot spot” or area within the virtual environment that a user may “enter” to get a special value by completing a special challenge.

The value collected by a user may be redeemed for prizes or other offerings. The value may be transferrable, i.e., the value may be shared or joined with the value of other users, and/or donated to various groups or charities. The value may alternatively or additionally have a variety of parameters or limitations put on it like timed limits, expiration dates, etc.

### I. Users and Platform

A. Compatibility

The computer system and the challenges offered within it may be compatible with all platforms, including Apple and Android platforms, Microsoft or other systems, open source systems, etc, and may be designed to be played on smartphones, tablets and online. The computer system may include a Graphical User Interface (GUI), Application Programming Interface (API), and/or other software, instructions, or code that provides for compatibility with all platforms. Alternatively, different versions of code may be created with each version being dedicated to supporting a specific platform, operating system, or smart phone.

B. Multiplayer Games

The preferred embodiments may include challenges played by single users. However, in another embodiment, the computer system may allow multiple consumers to participate in the same challenge, such as on the same team or as competitors. There may be a distinction between single play and multiplayer play. Also, in one embodiment, there may be real time vs non real time play. For instance, one user may play and then the user's score or results may be “compared” to the play or score of another user to determine a winner and award value. During multiplayer play, the winning team may split the value awarded or the value offered may be awarded to the winning participant. Other multiplayer challenges may be presented.

C. Remotely Accessing Challenges

Consumers may hear about the platform and its suite of challenges from many sources including word-of-mouth, online, an advertisement in a sponsoring store's location or website, user interaction with kiosks, or other sources. Consumers may download their first or initial virtual environment and/or challenge(s) in many ways, such as remotely downloading an App or other code from the computer system or a platform's website, a sponsoring partner's website, the App Store, etc. The computer system and method may provide a software link to websites that allow download of the App and/or challenges, dvd, other content, etc.

The actual App or code consumers download may be for a specific challenge (such as the exemplary challenge related to Union Station). Additionally or alternatively, consumers may download a “shell” App or code, which may come pre-loaded with certain challenge(s) and features to get users started. The computer system or platform provider may charge a fee for the first App (or challenge), or may wait to charge users until the users activate their account or purchase additional Apps (or challenges).

D. Downloading Other Challenges

The computer system may be configured such that once users have the App or other code related to an initial challenge installed on their machines, the users may easily search for and download other challenges. The computer system may provide in-App options to download new challenges directly from within their App, or options that may take them to the App Store or download a completely new App, such as from a website or the App Store. The computer system and platform may facilitate a straightforward process for users to access new challenges. Some challenges may have restricted access provisions that may require users to download separate code, such as a separate App. Users may be restricted from downloading specific challenges—the restrictions may be based upon age, from the sponsor, retailer, platform provider, organization, individual, etc. Programming options may be used to make the interface difference to the consumer minimal or non-existent. The computer system may periodically notify users of available challenges that may be of interest to them based upon user profile information and/or new challenges that have become available.

The challenges may be entertaining and, at the same time, may offer users relevant and valuable rewards. When a user first downloads the App, the user may be able to play for a limited amount of time and sample it, such as during a “Demo Play” period. The user may even earn “mock” rewards during the Demo Play. In order to continue enjoying the challenge and earn real rewards, the user may then be required to open an account and register.

E. User Profiles

Activating the user's account may, amongst other things, activate the full features of the challenge. In one embodiment, activation may require filling out some minimal information, i.e., name, email, password, username, address, gender, age, income, net worth, marital status, etc.

Preferably, the users may be prompted to provide additional information that will enable the computer system or platform provider, and the associated challenges, to provide relevant and attractive rewards. Additional profile information may include specific areas of interest or specific retailers that a particular user frequently patronizes and from which the particular user would want to earn rewards or other value.

The user account may have several sections including General User Info, the User Bank (and a Reward Management Section), General Reward Preferences, Challenge Specific Preferences, and/or General Preferences. Users may have an opportunity to choose from both General Reward Preferences and Challenge Specific Preferences.

General Reward Preferences may include user preferences related to general categories of goods and services that a user would like to receive as rewards. General Reward Preferences may include user preferences for products, services, brands, type of products, type of services, location(s), retailers, specific individual stores, chains, shopping or consumption habits, and/or other preferences.

Challenge Specific Preferences may be user preferences that relate to goods and services relevant to that particular challenge's sponsor(s), and/or user preferences for stores, products, services, etc. associated with a real world location or venue, a challenge, or a sponsor. For example, in the exemplary Union Station challenge, users may be prompted to provide Challenge Specific Preferences with respect to retailers located within Union Station that the users want to receive rewards from, and/or products/services offered at Union Station that the users want to receive as rewards.

Registering a profile may require the user to provide at least a minimal level of information. The user may be prompted to provide additional information that may enable the computer system and method to provide relevant and attractive rewards. For instance, additional profile information may include specific areas of interest or specific retailers that the user frequently patronizes and from which the user may want to earn rewards.

Profile information may also be for or aligned with different stages. As an example, if a user provides basic information, they may get access to a basic set of challenge(s) or other information discussed herein. On the other hand, the more information the user provides, the more content that the user may be able to access. The computer system may provide free and paid programs, such as providing a premium content offered to specific users that pay a certain amount for the use of the computer system.

The computer system may enable, use, or otherwise integrate third party games and/or other content. For example, the computer system may enable a simulation type of game to offer rewards, value, advertising, or other promotions. The computer system may include dedicated hardware, and/or provide an API to enable integration with third party system criteria while the computer system of the present embodiments provides the content, i.e., the ads, rewards, etc.

The computer system and method may allow users to specify non-profit organizations to which the users may direct value, either directly (i.e., by donating points the users have earned to a charity) or indirectly (the computer system and method may offer to donate $X to a charity designated by the user for every $XX of rewards or value the user earns or redeems).

Users may be given the opportunity to enable the computer system and method to offer the users location-based rewards by enabling GPS-based functionality, such as by retrieving a GPS (Global Positioning System) location from a hand-held device of a particular user having a GPS unit. For instance, the computer system may receive the GPS location of a hand-held device of the user, and send location-based available rewards or value and/or advertising to the hand-held device of that user in real-time or almost real-time.

The more robust the user's profile is, the more relevant and valuable rewards or value the computer system and method may be able to offer that user, and the more valuable that user may be to advertisers. The computer system and method may provide incentives to users to provide profile information beyond the basic requirements, including preferences related to products, services, retailers, brands, and shopping habits. Incentives may include rewards, value, points or other consideration in return for a user entering full profile information and preferences.

The computer system may provide a virtual bank that includes a virtual bank account associated with the user. The virtual bank may be the repository for all the points, rewards, and/or value that a user accumulates through any and all of the challenges that the user downloads or uses. Users may be able to access their virtual bank account from within any challenge and monitor their balances, as well as remotely make redemptions or transfers over a communications network. In addition, there may be Reward Management functions that the users may take advantage of, such as functions related to the exchange of points, rewards, or other value being offered by one sponsor for other points, rewards, or value being offered by other sponsors.

F. Value

Prior to, during, or after completion of challenges, users may accumulate points, rewards, or other value that may be relevant to each user based upon preferences and tastes that the user specifies in their user profile. Rewards may consist of coupons, rebates, or similar consideration offered by promotional partners. The typical promotional partner may be a retailer affiliated with a challenge sponsor. In the exemplary Union Station challenge, a popular local retailer having a store in Union Station may be a promotional partner, offering coupons to users for discounts, “giveaways,” and/or other prizes.

In other cases, a retailer may sponsor a challenge themselves and may be the sole provider of rewards or value. For instance, a pizza chain may sponsor a challenge wherein all the rewards or value will be for coupons or other prizes redeemable only at restaurants within the pizza chain. Retailer, sponsor, venue owner or the like may pay a platform provider to produce the challenge and/or may use the API or the computer system of the present embodiments to create their own challenge that meets certain creative and technical requirements.

Users may have a variety of ways to win points, rewards, and/or other value. Noted above, one example may be so-called hot spots that users may encounter within challenges. The hot spots may be controlled partly or fully by a sponsor and/or promotional partner. The sponsor and/or partner may determine a hot spot location, a special challenge associated with the hot spot, to whom the hot spot should be offered (such as determining criteria for the targeted audience), and/or other factors.

The promotional partner (retailer in the above case) together with the challenge sponsor and/or the platform provider may dictate the parameters for offering rewards or value, including the frequency and volume of offers; the value of coupons; conditions (such as expiration date) of rewards or value; and conditions for transferability (if any).

In addition to winning rewards or value, users may also accumulate points during game-play. Points may accumulate from game session to game session or from challenge to challenge, and users may have many options for redeeming the points for value. For instance, users may be able to “cash in” a certain number of points for a coupon at a participating promotional sponsor's store, for airline miles or the like, or other third-party rewards or value. Points may expire and/or be transferrable to family members, friends and/or organizations. The Reward Management Section provided by the computer system may automatically sort and organize points, rewards, and/or other value.

The points may automatically convert to specific rewards or other value, once again based upon criteria established by the sponsor and/or promotional partner. As an example, automatically the user may receive a Starbucks' coupon when the user gets 10 points, and with the next 5 points, the user may automatically get a coupon to another store or restaurant, such as an ice cream parlor or a pizza place. The auto selection may be in part based upon the General Reward and Specific Challenge Reward Preferences of the user.

While coupons and merchandise are the most direct way of providing value to the users, there may be a number of non-direct benefits that the computer system and/or platform provider may provide to users. The platform provider may partner with nonprofit organizations and allow users to use their points, rewards, and/or other value philanthropically or to aggregate points, rewards, and/or other value on behalf of the nonprofit.

In other systems, users may have the opportunity to win points, rewards, and/or other value and then direct that those points, rewards, and/or other value go toward planting a tree or to some other social cause rather than cash them in for merchandise, coupons, services, or the like, or to benefit a charity in some way. The computer system may allow users to designate some or all of their points to go to a qualified non-profit partner who, in turn, may use those points for rewards/value or who will, in some other way, benefit from the donation. The computer system may also make offers to users to donate automatically a given amount of money to a qualified non-profit for every $X that the user earns in coupons or for every X number of points they earn or redeem.

Users may be encouraged to recommend qualified charitable organizations for the platform provider to make available for contributing to via the computer system. The platform provider may also actively solicit charitable institutions to “push” participation from by its benefactors. The platform provider may make points valuable to redeem for coupons to support promotional partners. The platform provider may also seek to make the points used within the computer system valuable beyond the App itself.

The points used within the computer system may be valuable not only to the users, but also to retailers outside the computer system in as much as consumers may be induced to patronize a retailer, airline, venue, downtown area, mall, store, or other area or enterprise that accepts points of the computer system. As the system grows, nontraditional ways may be developed to further monetize the points used within the system. The platform provider may affiliate with airline mileage programs, venue programs, or other affinity programs to facilitate cross-usage of miles or points on each other's systems.

Additionally or alternatively, the computer system may provide a “Points Exchange” with a network of affiliated partners and arrange for users to be able to use their points with the affinity programs and with such vendors as Amazon, online merchants, venue websites, and others. The Points Exchange may be a virtual marketplace for points, such as a website that allows users to redeem value or rewards, including points, such as by purchasing products or services from various merchants or vendors. The Points Exchange may allow users to trade value or rewards, including points, as well. For instance, 100 points at Amazon.com® may be tradable for less, more, or the same amount of points at Starbucks, eBay®, a specific venue, or other store/location. Alternatively, the Points Exchange may allow users to redeem points associated with credit card programs, airline mileage programs, venue associated programs, and/or other reward programs. There may be targeted Apps in this area. For example, the platform provider may say to a company, such as Amazon, that the computer system and/or users thereof may have X value of rewards expiring in the electronics area and maybe the company would be interested in doing a 10 day exchange for specific Amazon equivalent points. Other swaps and exchanges may be used.

The computer system and platform may provide its API broadly to allow third-party programmers to develop complementary Apps, programs, or challenges to enhance the virtual experience. For instance, third-party program developers may create add-on features to facilitate point-transfer.

The present embodiments may include an API to create template challenges. The template challenges may be theme, venue, location, product, service, brand, retailer, or sponsor based. For instance, challenges may be directed to various venues, downtown areas, shopping malls, type of products (automobiles), type of services (travel or leisure), and/or locations (downtown New York City, downtown Chicago, etc.)

### II. Challenge Sponsors and Promotional Partners

A. Challenge Sponsors

The platform provider may partner with diverse sponsors to introduce many challenges. Noted above, an exemplary challenge may take place within a virtual likeness of Union Station or other venue. As such, the target audience may include D.C. commuters, tourists, and/or locals. The sponsor may be Union Station or retailers therein, and the promotional partners may include one or more of the retailers having locations within Union Station.

B. Quality of Challenges

Users may be able to simulate walking or moving through the virtual mall (or other venue) and encounter in virtual space what they may encounter in the real Union Station, including the same restaurants, stores and kiosks; crowds of people; billboards and other advertising and/or more. There may be obstacles for the users to overcome and challenging tasks or games to complete within a virtual representation of the real world venue.

Over time, more challenges may be developed and offered. Sponsors may include venue managers, such as mall owners, retailers and/or other establishments. The challenges may typically include, like Union Station, virtual facsimiles or computer simulations of, or otherwise be based upon, real world locations, environments, venues, and/or other areas.

The platform provider may work with challenge sponsors to create a product or computer system that suits the sponsors. Some Apps may be “open”, “restricted” or “censored,” and/or “closed.” An open App may allow users maximum ability to go from one challenge to a different challenge within the virtual environment.

A sponsor may want a closed App wherein a user cannot go directly from one of that sponsor's challenges to a non-affiliate's challenge. For instance a large mall owner may have a suite of challenges based upon their malls. That sponsor may want their challenges to form a closed system.

A middle option or level of accessibility may allow a sponsor to restrict access from their challenge to certain other challenges. For instance, a child-focused or teen-focused challenge sponsor may not want users to be able to transfer directly to an age-inappropriate challenge, like one sponsored by a beer company, and vice versa. The platform provider may work with the sponsors to address their particular needs, and configure the computer system accordingly.

Regardless of whether a user plays within an Open App, a Closed App, or a Restricted App, the value (whether rewards, points, or other value) and/or other information may accumulate to the same unique user account. The users may always have remote access to their user account that displays up-to-date value accumulated by the user.

C. Using Logos of Retailers

The platform provider may work with its challenge sponsors to ensure appropriate and legal use of the logos and branding graphics that the challenge may desire to use to enhance the users' experience within the virtual environment.

D. Retailer Promotional Partners

Retailers may have a variety of options for partnering with challenges and/or working directly with the platform provider and/or tailoring the computer system. The retailers may advertise within challenges (banner ads, interactive ads, etc.); provide coupons or other promotional consideration, such as in-challenge rewards; and/or offer coupons or other consideration directly to users in exchange for redeeming points or other value.

The platform provider and the challenge sponsor may work with the retail promotional partners to develop a computer system and/or promotional plan that accomplishes their goals and addresses their needs. The sponsor and platform provider may both participate in the fees generated by advertising and promotion presented by the computer system. The revenue sharing model may vary from challenge to challenge and/or from sponsor to sponsor.

As an example, in the first phase of a roll out, the exemplary Union Station challenge may offer value from one Union Station-based retailer, such as a yogurt store. In future roll outs, more retail promotional partners may be added to the exemplary Union Station challenge and, eventually, introduce new challenges based in part upon different venues. The new or updated challenges may be remotely downloaded to hand-held or other computing devices of users.

E. Dashboards

The computer system and/or platform provider may provide challenge sponsors and promotional partners information about their challenges, promotional offers and advertising through web and mobile-based “dashboards.” Dashboards may include user interfaces that provide statistical and information summaries, such as summaries on user demographics, trends, preferences, redemptions, outstanding value offered and/or awarded to users, and other information. Dashboards may be used to control various options, such as rewards, points, value, challenges, the terms of the value presented, and/or other content presented via the computer system.

Promotional partners may have access to information such as how many of their rewards were offered, accepted, and/or ultimately redeemed or transferred by users. In addition to providing this and other information, the dashboards may provide profile information, and where available, describe users that accepted or did not accept offers. Partners who advertise in-challenge, or even pre-challenge and/or post-challenge, may have access to information relevant to their advertising.

The challenge sponsors may be provided with the same information as promotional partners. Moreover, sponsors may have the similar type of information for all the retail partners promoting or advertising within that challenge. Challenge sponsors may also have user information for their challenge, including how many people are using the challenge, how long users are using the challenge, if users are return users of the challenge, and/or user profile-based information.

The computer system and/or platform provider may have a higher level dashboard offering the platform provider data across all challenges and across all retail promotional partners and sponsors for analysis. Alternate dashboards having additional, fewer, or more features may be used.

F. Revenues

The computer system may generate revenues from diverse sources. Potential revenue may come from some of the following: charging a nominal amount for downloading challenges and/or associated App's; charging for in-game advertising; earning a fee in connection with the Point Exchange noted above; earning revenue from challenge sponsors; earning a per-unit fee on rewards/value; and/or earning a fee from developers using the API(s) that the computer system provides for both challenge development and/or application development (features and functions offered within and outside of the virtual environment, challenges, or App(s), such as an enhanced reward management system). Fees generated from the computer system may include fees from third party developers, affiliate fees, credit card processing fees, development fees tied to producing challenges, and/or other fees.

### III. Exemplary Computer System

In one aspect, a computer system may be provided. The computer system may be, for example, a hand-held computing device, such as a smart phone. The computer system may be configured to present targeted advertising information to a user within a gaming or virtual environment. The computer system may include a memory for storing instructions and code for presenting the virtual environment or computer simulation representing a real world environment on a display screen, and accepting user instructions allowing the user to move or navigate about the virtual environment. The real world environment may be a shopping mall or other actual venue, such as a downtown area, and the virtual environment may include one or more virtual stores depicting actual shops that a user may know or recognize. The computer system may include a processor configured to retrieve advertising information associated with the one or more virtual or actual stores and user profile information stored in the memory. The user profile information may detail product, service, brand, retailer, location, shopping or other preferences of the particular user, including those discussed elsewhere herein. The processor may be further configured to present gaming or virtual challenges to the user within or superimposed upon the virtual environment. Before or as the user progresses through the challenge, and/or upon successful completion of the challenge, the processor may award value to a virtual banking account of the user that the user may subsequently redeem or transfer, such as in-person, or remotely and electronically via a wireless or wired communications network, such as the internet.

The computer system may allow the user to electronically transfer the value in the virtual banking account to another person or an organization via the processor and communications network. The processor may select the advertising information to be displayed within or superimposed upon the virtual environment based upon user preferences in the user profile information, past user shopping activity, user location, sponsor or retailer criteria, and/or other factors disclosed herein. The processor may also select a challenge and/or value to present to the user within or superimposed upon the virtual environment (representing a real world venue) based upon user preferences in the user profile information, past user shopping activity, user location, sponsor or retailer criteria, and/or other factors disclosed herein. The value offered and/or awarded before or during a challenge, or after successful completion of the challenge, may also be selected based upon user preferences in the user profile information, past user shopping activity, user location, sponsor or retailer criteria, and/or other factors disclosed herein.

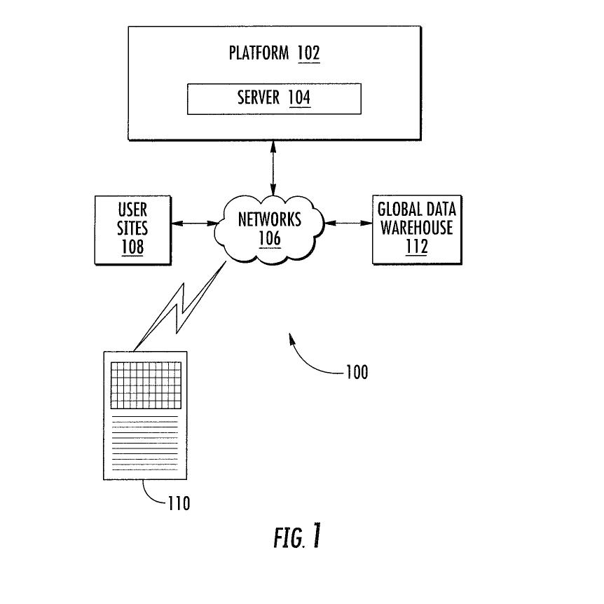

FIG. 1 illustrates an exemplary computer system 100 configured to present targeted advertising, rewards, value, and/or challenges to a particular user within a virtual environment based at least in part upon user profile information. The computer system 100 may include a platform 102 having a server 104, one or more networks 106, user sites 108, user devices 110, and a data warehouse 112. The computer system may include additional, fewer, or alternate components.

The computer system 100 may be directed by a platform provider. The platform provider may control the computer system 100 from a location having a hardware or physical platform 102. The hardware platform 102 may include a server 104, one or more controllers or processors, one or more memory units, one or more databases, and/or other components. The platform 102 may include modems, transceivers, and/or other communication devices for communication over various networks 106, such as the internet.

The communication networks 106 may be integrated with the cloud or cloud related services, and/or be interconnected with one or more databases 112. The databases 112 may store data related to advertising or promotion information, user profile information, challenges, user bank accounts, rewards/value information, and/or other types of information discussed herein.

There may be user sites or computers 108 interconnected with the communication networks 106. For instance, the user sites and/or computers 108 may be local computers associated with sponsors or promotional partners, such as various stores, shops, malls, cities, counties, provinces, or other venues or other areas associated with one or more merchants.

The user devices 110 may be smart phones, tablets, or other smart or computing devices. The user devices 110 may be configured for wireless communication with the communication networks 106, and thus with the platform provider via the platform 102 and server 104. The computer system 100 may include other configurations and integrated devices.

### IV. Exemplary Computer-Implemented Method

In another aspect, a computer-implemented method associated with presenting targeting advertising, value, and/or challenges, and/or awarding targeted or other value before, during, or upon successful completion of challenges may be provided. The computer-implemented method may include displaying a gaming or virtual environment on a display screen. The virtual environment displayed may include a virtual representation or computer simulation of a real world location or venue having a number of merchants/stores. The computer-implemented method may include accepting user input directing movement or navigation through the virtual environment, such as directing first or third person movement or moving an icon representing a user through the virtual environment. The computer-implemented method may include retrieving advertising information associated with a store located within the real world location or other venue, and a user profile from a memory via a processor. The user profile may include user preferences, including those discussed herein. The computer-implemented method may include creating targeted advertising based upon the user preferences. For example, the computer-implemented method may include filtering the advertising information using the user profile and preference information to identify targeted advertising information via the processor or other means of creating the targeting advertising information, such as by using category flags, demographics, or the like. The computer-implemented method may also include presenting the targeted advertising information within the virtual environment on the display screen; and presenting a challenge to the user within or superimposed upon the virtual environment. Before or during the challenge and/or upon successful completion of the challenge by the user, the computer-implemented method may include awarding targeted, general, or other rewards/value to a virtual bank account of the user via the processor; and allow subsequent electronic redemption or transfer over a communications network of the rewards/value accumulated in the virtual bank account.

The advertising information may be filtered using user preferences stored in the user profile information, past user shopping activity, a GPS location of the user or of the hand-held device of the user, sponsor or retailer criteria, and/or other factors, including other factors discussed elsewhere herein. The value accumulated in the virtual bank account may be redeemed by the user either conducting a commercial transaction, transferring the value to another person or an organization, or other means. The value accumulated may include points, prizes, coupons, rebates, and/or other rewards.

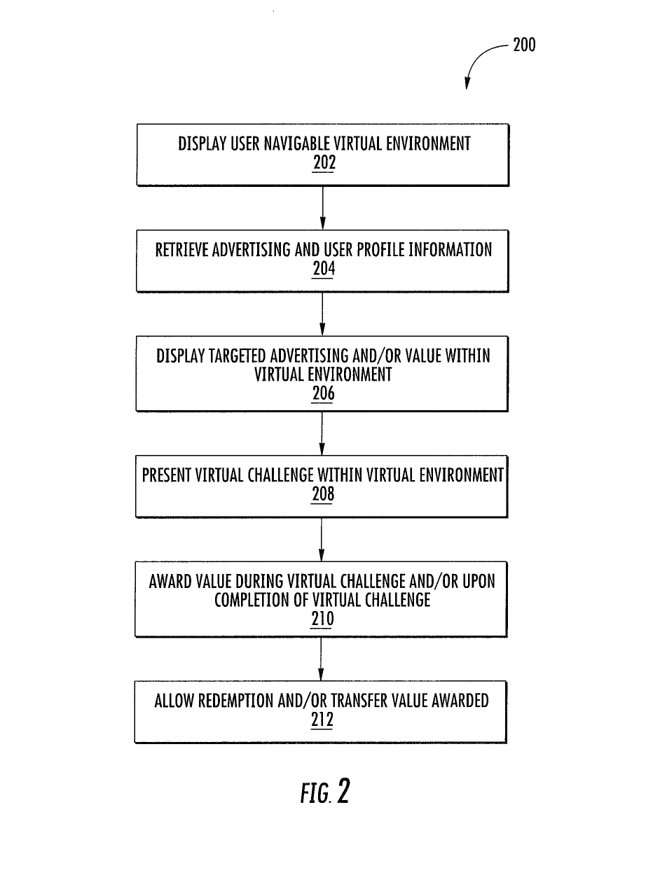

FIG. 2 illustrates an exemplary computer-implemented method 200 of presenting targeting advertising, value, and/or challenges to a particular user within a virtual environment (virtually representing or graphically depicting a real world venue or location) based at least in part upon user profile information. The computer-implemented method 200 may include displaying a user navigable virtual environment on a display screen 202; retrieving advertising information and/or user profile information 204; displaying targeted advertising and/or value within the virtual environment on the display screen 206; presenting a virtual challenge within the virtual environment 208; awarding value during and/or upon completion of the challenge 210; and/or redeeming and/or transferring the value awarded 212. The computer-implemented method may include additional, fewer, or alternate actions.

The computer-implemented method 200 may include displaying a gaming or virtual environment on a display screen 202. The gaming or virtual environment may be a virtual representation or computer simulation of a real world location or venue, such as a shopping mall, city, downtown area, stadium, or other location, including locations with multiple physical shops and vendors. The virtual environment displayed may allow the user to travel or move about the virtual environment in either two or three dimensions.

The computer-implemented method 200 may include retrieving advertising information associated with stores or vendors within the real world location and user profile information from a memory via a processor 204. The user profile information may include the user preferences and other information disclosed herein.

The computer-implemented method 200 may include creating targeted advertising information. The targeted advertising information may be created by filtering the advertising information using the user profile information via the processor. For instance, the specific advertising information may be associated with coffee or pizza, or another category of products and services. Users that identify a preference for coffee or pizza (or other service or product) in their user profiles may be then be sent specific advertising information that is categorized as pertaining to coffee or pizza (or other product or service preferred by the user). In other words, the advertising information may be categorized, such as by product, service, brand, sponsor, retailer, location, etc. Users that have user profiles that identify a preference for that category of offering may then automatically receive that advertising information as targeted advertising information.

The computer-implemented method 200 may include displaying the targeted advertising within the virtual environment on the display screen 206. The targeted advertising may be pop-up, banner, interactive, and/or other forms advertising. The targeted advertising may be via photos, icons, windows, and/or other virtual or audio representations.

The computer-implemented method 200 may include presenting to the user a virtual challenge within the virtual environment on the display screen 208. The challenge presented to the user may be based upon sponsor or promotional partner criteria, user profile information, and/or other factors as discussed herein. The challenge may be targeted to a large or small group of users, such as people that like coffee or pizza (or other products and services), and/or users that often visit a particular store.

The computer-implemented method 200 may include awarding value to the user 210. Before the challenge and/or as the challenge progresses, and/or upon successful completion of the challenge, the processor may award value or even targeted value to the user. The targeted value may be selected based upon sponsor criteria, user preferences in the user profile, and/or other factors, including those discussed herein. For instance, targeted value, such as coupons or rebates for coffee (or other products/services), may be directed to users that have identified a preference for coffee (or other products/services) or to users that have been found to often travel to Starbucks or other coffee houses (or other product/service vendors), such as by GPS tracking or other data tracking. The value or targeted value offered may be awarded before, during, and/or after the challenge.

The computer-implemented method 200 may include redeeming and/or transferring the value awarded 212. The user may remotely, such as electronically over a communications network, or in-person redeem the value accumulated in his or her virtual bank account. Additionally or alternatively, the user may electronically transfer his or her value to friends and/or organizations over a communications network. Users may also be able to transform their points, rewards, or other value into other for of value, such as by exchanging airline miles into coupons for pizza or generic points usable for other products, services, rewards, and/or value.

### V. Exemplary Computer System Functionality

The computer system may include the use of a processor or computing device, such as a hand-held computing device, smart phone, laptop, desktop, or other computing device. The computer system may provide features and functionality that includes navigation within a virtual environment or computer simulation. The navigation may be by touch (such as on a touch screen), by keyboard or buttons, or by icons on a user interface or within the virtual environment.

The virtual environment generated by the computer system may provide a two or three-dimensional representation of a real world location or venue. The virtual environment and challenges may be programmed in various programming languages, such as C, C++, Turbo C++, Java, object orientated programming languages, and/or other programming languages known to one of ordinary skill in the art.

The computer system may facilitate tying advertising, rewards, and/or value to a real world venue or actual stores/merchants within the real world venue via a navigable computer simulation of the real world venue. The computer system may allow the user to virtually travel within or around the two or three-dimensional representation or computer simulation of the real world location or venue provided by the virtual environment. The two or three-dimensional representation of a real world location may include a computer simulation or virtual depiction of a real world or actual building, multi-story structure, area, street, stadium, airport, city, county, state, province, country, and/or other venue, including venues including multiple vendors. The real world-based computer simulation may allow the user to navigate within and about the virtual real world location. Challenges and rewards may graphically appear within the virtual real world location when the user moves a virtual user or icon within or near the vicinity of a real world area. For instance, when the user navigates into a coffee shop, a challenge sponsored by the coffee shop (and/or a mall or other venue in which the coffee shop is located) may be presented on or superimposed upon the top of the virtual depiction of the real world coffee shop.

Also, as the user progresses through a virtual environment and/or challenge, noted above, a hot spot or challenge may be dynamically generated and presented on the display screen, such as being superimposed upon the top of the virtual depiction of the real world location. A hot spot may be a challenge presented within a virtual environment, or a short or mini-challenge presented within or inside of a larger challenge currently being presented within the virtual environment. The hot spot (or challenge, or challenge within a challenge) may be dynamically generated within the virtual environment based upon various factors or various combinations of factors, such as sponsor criteria (which may include sponsor preferences based upon demographics, products or services to be pushed, time of day or day of week promotions or offerings that are to be offered, the age or wealth of target audience, and/or other criteria), user preferences, the real world location of the user, the virtual location of the user within the virtual environment, and/or other factors, including those discussed herein.

For instance, once a user moves for example from level one to level three of a shopping mall or other venue, a hot spot may be displayed that relates to a store sponsoring a challenge and/or offering value or promotions that is located on the third level of the shopping mall or venue. The user may obtain value for navigating within the virtual shopping mall or venue and entering the virtual store sponsoring the challenge and/or offering the value. Once within the virtual store, targeted advertising associated with the virtual store and/or directed toward the particular user based upon user preferences or other factors may be presented to the user.

In one embodiment, the computer system and method may allow the user to travel around the virtual environment in such a manner that is common with first person shooter games, such as Halo, Doom, or other games. The user may be presented with a first person view of the virtual environment, a third person view of the virtual environment that may include a virtual representation of the user, and/or another virtual representation of the user, such as by icon or graphic depiction. The user may be able to switch views of the virtual real world location or venue being presented on a display screen. The virtual representation of the user may walk, run, jump, duck, move, etc. within the virtual environment, such as while the user attempts to complete certain challenges and/or collect value.

The computer system and method may allow the user to move within the virtual environment directly or indirectly from one challenge to the next challenge or another challenge selected by the user. Other virtual environments may be used.

The computer system may create virtual coins or points. For instance, the computer system and method may provide functionality for generating and awarding points and/or other value to the user (such as after selection of a certain icon or virtual representation of a coupon or prize, and/or before, during, or after the successful completion of a challenge by the user). The computer system may provide functionality for depositing the points or other value in a virtual bank account of the user, and for redeeming the points or other value in the virtual bank account. Additional, less, or alternate functionality may be provided.

The computer system may generate hot spots, such as locations within the virtual environment/venue at which targeted challenges may be presented to a user. The targeted challenges may be presented to particular users based upon sponsor criteria; user preferences from a user profile; past user shopping or other activity; GPS location of a computing device of a user; rewards, prizes, or other value to be offered; and/or other factors, including those discussed herein.

The computer system may monitor and gather data regarding the shopping, redemption, consumption habits, and other activity of a user. The data and information gathered related to the past user activity may be stored as part of the user profile and subsequently used by the computer system to present targeted challenges, targeted advertising, and/or targeted rewards to the user.

The computer system may generate and use virtual banks. The virtual banks may have virtual user bank accounts for aggregating rewards, points or coins, and/or redeeming points or other value for challenge rewards and/or other products or services. The virtual banks may allow users to use coupons on-line or by physically being in a real world store. The virtual banks may allow users other uses for points, such as affinity points or for charity.

The computer system may include global user profiles and/or challenge specific user profiles. Information based upon usage and experience may be collected and analyzed by the computer system. The user profiles may include user preferences for particular likes and/or dislikes of the users, such as user preferences for products, services, brands, retailers, type of challenges, type of value or rewards to be offered, and/or other preferences.

The computer system may generate and display a retailer dashboard. The retailer dashboard may include a user interface that displays user information (such as user profile information), usage and activity information associated with users or groups of users, advertising information, coupon information, and comparisons to other sponsors or retailers. The retailer dashboard may present various statistics, such as statistical information regarding sales, consumers, trends, advertising, coupons, market share, competitors, products, services, and/or other information.

The computer system may generate and display a venue dashboard. The venue dashboard may include a user interface that displays user information (such as user profile information), usage and activity information associated with users or groups of users, advertising information, coupon information, and comparisons across retailers and/or challenge sponsors. The venue dashboard may present various statistics, such as statistical information regarding sales, consumers, trends, advertising, coupons, market share, competitors, products, services, retailers, sponsors, organizations, and/or other information.

The computer system may present various types of advertising. Banner advertising, pop-up advertising, interactive advertising, and other types of advertising may be generated and displayed within the virtual environment. The banner advertising, pop-up advertising, interactive advertising, and/or other types of advertising may be targeted to specific users or types of users. For example, particular advertising messages may be sent to challenges that certain users are using based upon sponsor or retailer criteria; user preferences from a user profile; past user shopping or other activity; GPS location of a computing device of a user; rewards, prizes, or other value to be offered; trends, demographics, and/or other factors.

The computer system may include offering rewards and prizes associated with a challenge. Coupons and other offers may be presented to the user before, during, and/or after successful completion of challenges. Prizes and rewards may also be offered before, during, and/or after successful completion of challenges. Functionality may be provided for cashing in points/coins for rewards or affinity points, for donating them to a charity, and/or transferring them to another person.

The computer system may include other forms of deliver or variations. For instance, the computer system may include a processor, memory, display, transceiver and/or other components that are embedded into larger consumer products, such as refrigerators, stoves, microwaves, cars, boats, planes, buildings, elevators, clothing, etc. The computer system may integrate social media sites, such as Facebook, Twitter, Instagram, etc., for presenting the content discussed herein. For instance, by integrating social media sites, friends may be able to participate in the same challenges and/or exchange value easier.

The computer system may be provided by a governmental organization and present various types of benefits or programs to users in a targeted way. For instance, social security information may be presented to users based upon age, and Medicare information presented to users based upon medical information.

While the invention has been described above by reference to various embodiments, it should be understood that many changes and modifications can be made without departing from the scope of the invention. The description and illustrations are by way of example only. Many more embodiments and implementations are possible within the scope of this invention and will be apparent to those of ordinary skill in the art. The various embodiments are not limited to the described environments and have a wide variety of applications.

It is intended in the appended claims to cover all such changes and modifications which fall within the true spirit and scope of the invention. Therefore, the invention is not limited to the specific details, representative embodiments, and illustrated examples in this description. Accordingly, the invention is not to be restricted except in light as necessitated by the accompanying claims and their equivalents.

What is claimed is:

1. A computer system configured to present targeted advertising information to a user within a virtual environment, the computer system comprising:
a memory unit for storing instructions for presenting a virtual environment representing a real world environment and allowing user navigation through the virtual environment, the real world environment being a shopping mall or other venue and the virtual environment includes one or more virtual stores within the shopping mall or other venue; and
a processor configured to retrieve advertising information associated with the one or more virtual stores and user profile information stored in the memory unit, the user profile information detailing shopping preferences of a user,
wherein the processor is configured to retrieve the instructions from the memory unit and present the virtual environment representing the real world environment on a display screen and accept user input directing virtual navigation through the virtual environment, and to present (1) targeted advertising based upon the user profile information and (2) virtual challenges to the user within the virtual environment on the display screen, and during or upon successful completion of a virtual challenge, the processor awards value to a virtual banking account of the user that the user may subsequently redeem or transfer over a communications network.

2. The computer system of claim 1, wherein the user may electronically transfer the value in the virtual banking account to another person or an organization via the processor.

3. The computer system of claim 1, wherein the processor selects the targeted advertising to be displayed within the virtual environment based upon user preferences in the user profile information, past user shopping activity, and user location.

4. The computer system of claim 1, wherein the processor selects rewards to offer to the user during the virtual challenge based upon sponsor criteria and past user shopping activity.

5. The computer system of claim 1, wherein the processor selects value to offer to the user during the virtual challenge based upon user preferences.

6. The computer system of claim 1, wherein the processor selects the virtual challenge to present to the user within the virtual environment based upon user preferences.

7. The computer system of claim 1, wherein the processor dynamically generates the virtual challenge within the virtual environment based upon sponsor criteria and user information.

8. A computer system configured to present targeted advertising information to a user within a virtual environment, the computer system comprising:
a memory unit for storing instructions for presenting a virtual environment that includes a virtual representation of a real world environment and allowing user navigation through the virtual environment, and user profile information detailing preferences of a particular user; and
a processor configured to retrieve the instructions from the memory unit and present the virtual environment representing a real world environment on a display screen and accept user input directing virtual navigation through the virtual environment, the processor further configured to present both targeted advertising information based upon the user profile information and a virtual challenge within the virtual environment on the display screen;
wherein, when the particular user successfully completes the virtual challenge within the virtual environment, the processor awards value to a virtual bank account of the particular user, the value being redeemable by the particular user when making a purchase or electronically transferable from the particular user to another person or an organization via a communications network.

9. The computer system of claim 8, wherein the processor selects the targeted advertising information to be displayed within the virtual environment based upon user preferences stored in the user profile information, past user shopping activity, and/or user location.

10. The computer system of claim 8, wherein the processor selects prizes or coupons to present during the virtual challenge based upon sponsor criteria and user preferences stored in the user profile information.

11. The computer system of claim 8, wherein the value presented during the virtual challenge is selected based upon user preferences in the user profile information and past user shopping activity.

12. The computer system of claim 8, wherein the processor dynamically generates the virtual challenge within the virtual environment based upon sponsor criteria and user information.

13. The computer system of claim 8, wherein the processor selects the virtual challenge to present within the virtual environment based upon user preferences.

14. A computer-implemented method associated with presenting targeted advertising within a virtual environment displayed on a display screen, the computer-implemented method comprising:
displaying a virtual environment on a display screen, the virtual environment including a virtual representation of a real world venue;
accepting user instructions directing navigation through the virtual environment displayed on the display screen;
retrieving advertising information associated with a store within the real world venue and a user profile from a memory via a processor, the user profile including user preferences;
filtering the advertising information using the user profile information to identify targeted advertising information via the processor;
presenting the targeted advertising information within the virtual environment displayed on the display screen;
presenting a challenge to the user within the virtual environment;
upon successful completion of the challenge by the user, awarding value to a virtual bank account of the user via the processor; and
accepting user instructions over a communications network to electronically redeem or transfer the value accumulated in the virtual bank account.

15. The computer-implemented method of claim 14, wherein the advertising information is filtered by the processor using user preferences stored in the user profile information and past user shopping activity.

16. The computer-implemented method of claim 14, wherein the advertising information is filtered by the processor using user preferences stored in the user profile information, past user shopping activity, and GPS (Global Positioning System) location of the user.

17. The computer-implemented method of claim 14, wherein the value accumulated in the virtual bank account is redeemed by the user electronically transferring the value to another person or an organization over the communications network.

18. The computer-implemented method of claim 14, wherein the value accumulated includes coupons or rebates.

19. The computer-implemented method of claim 14, wherein the value offered during the challenge is selected by the processor based upon user preferences stored in the user profile.

20. The computer-implemented method of claim 14, wherein the challenge presented within the virtual environment is selected by the processor based upon sponsor criteria and user preferences.
